(19) United States
(12) Patent Application Publication
(10) Pub. No.: US 2006/0251295 A1
(43) Pub. Date: Nov. 9, 2006

(54) Method and device for evaluating defects in textile structures

(76) Inventor: Rolf Leuenberger, Pfaffikon (CH)

Correspondence Address: BUCHANAN, INGERSOLL & ROONEY PC, POST OFFICE BOX 1404, ALEXANDRIA, VA, 22313-1404, US

(21) Appl. No.: 10/533,114

(22) PCT Filed: Nov. 3, 2003
(86) PCT No.: PCT/CH03/00316

§ 371 Date: Jun. 29, 2006

(30) Foreign Application Priority Data
Nov. 6, 2002 (CH) 1862/02

(51) Int. Cl. G06K 9/00

(52) U.S. Cl. 382/111

(57) ABSTRACT

The invention relates to a method for identifying defects in a textile fabric whereby signals are derived from the textile fabric and are processed at least with pre-determined parameters. The invention also relates to a device for identifying defects in a textile fabric. The device includes a sensor, a processing unit and an input/output unit. The processing unit is connected to the sensor and to the input/output unit and is embodied and arranged in such a way as to process signals detected by the sensor on the textile fabric, at least with pre-determined parameters, and produces an output signal which indicates the defect in the textile fabric. In order to adapt parameters of the method and the device for identifying defects in a textile fabric to a determined textile fabric subjected to a defect identification process, in an especially simple and rapid manner, a fixed data carrier of the predetermined parameters is subjected to the action of a sensor and a sensor is embodied and arranged in such a way as to read the pre-determined parameters of the fixed data carrier.

The invention relates to a method and a device for evaluating defects in textile fabrics.

WO00/06823 discloses a method and a device which enable a repeatable and unambiguous evaluation of defects in textile fabrics to be carried out. In this case an image of a fabric is formed and at least two representations of defects in the fabric appear in the image, these differing with regard to length and contrast or intensity of the defect. Taking these representations as a starting point, a decision as to the admissibility and inadmissibility of a defect in the fabric is made on the basis of the visual impression. A table- or matrix-like arrangement of representations of defects of differing conspicuousness is created for this purpose. An image of the flawless fabric serves as a background here. Sensitivity curves which are incorporated into the image may serve as additional aids for distinguishing between inadmissible and admissible defects.

In technical terms, this method or this device may give rise to an unnecessary flood of acquired data if all possible defects which can be classified are recorded. This prevents the defects from being evaluated quickly and results in unnecessarily generous dimensioning of the elements of which the device is to consist.

The object of the invention is therefore to provide a method and a device for evaluating defects in fabrics which also enable defects in different types of fabrics to be evaluated quickly and in a standard manner and therefore also different types of fabric to be compared with one another in terms of quality.

This is achieved in that, taking two selected parameters as a basis, a classifying matrix for the defects is created in which class limits divide the classifying matrix into fields, and values of two parameters such as, for example, the extent and the intensity of the defects, determine the class limits. The classifying matrix is additionally divided into at least two areas, for example for admissible and inadmissible defects.

The defects in the fabric are to be recorded according to a known method, and values for the two above-mentioned parameters are to be established. The recorded defects are assigned to the fields or classes in the classifying matrix according to values of the parameters which are measured for them.

A particular proposal lies in selecting a classifying diagram or a classifying matrix in which pixels and defects of a fabric which are represented by pixels can be arranged or classified according to their intensity and extent. Values for the intensity are to be plotted along an axis in an area which is independent of a fabric under consideration and may apply, as far as possible, to all possible fabrics. The zero point of this axis or the lower boundary of this area may optionally be located such that, given highly homogeneous fabrics, irregularities in the imaging can hardly be considered as defects. Pixels which, for example, are associated with the normal woven fabric structure of a woven fabric are to be recorded between this zero point and an upper limit, which depends on the relevant fabric which is to be examined. Events with intensity values above this limit are either only counted or, as from a predeterminable intensity, rated as defects which are unacceptable. Pixels which do not reach the limit are not further processed, for example, and therefore also do not load the system. This limit is calculated separately for bright pixels and dark pixels in a learning step, this taking place from a group of the brightest pixels for dark fabrics and a group of the darkest pixels for bright fabrics or from the brightest and darkest pixels in the same fabric, as, for example, a woven fabric always comprises 50% grey pixels.

The advantages which are obtained by the invention are to be seen in particular in the fact that the defects in the textile fabrics can be assessed irrespective of properties which may vary from fabric to fabric and therefore usually render the evaluation difficult or invalidate it. Thus all defects are recorded according to the same standard values. The recording of non-disturbing defects is automatically adapted to the textile fabric under consideration. The method according to the invention also allows the assessment of examined fabrics to be automated and carried out without human intervention.

The invention is illustrated in detail in the following on the basis of an example and with reference to the accompanying drawings, in which:

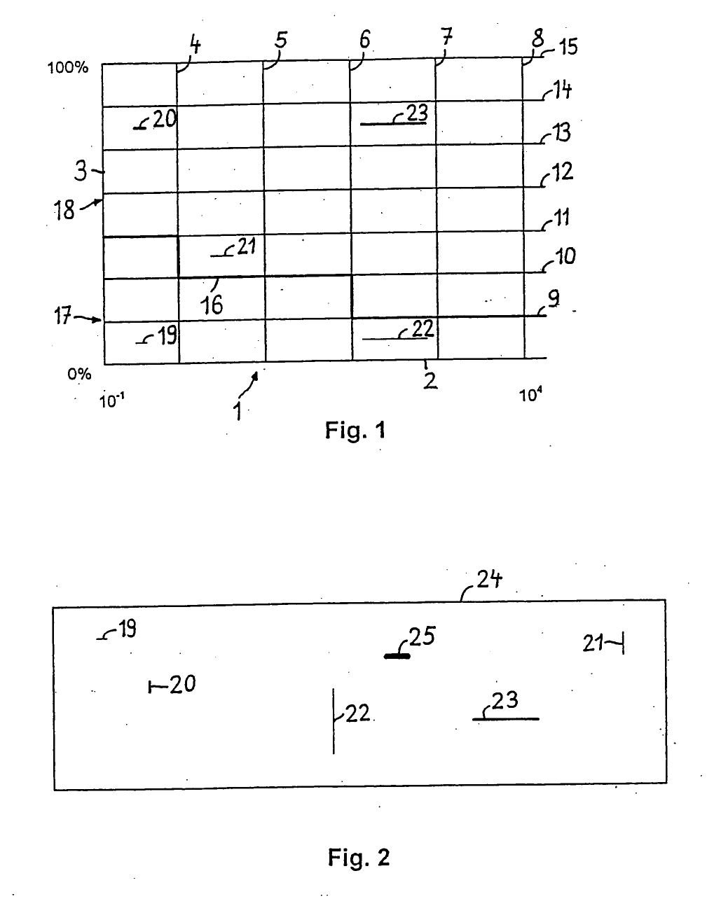

FIG. 1 is a representation of a classifying matrix,

FIG. 2 is a diagrammatic representation of a textile fabric with defects,

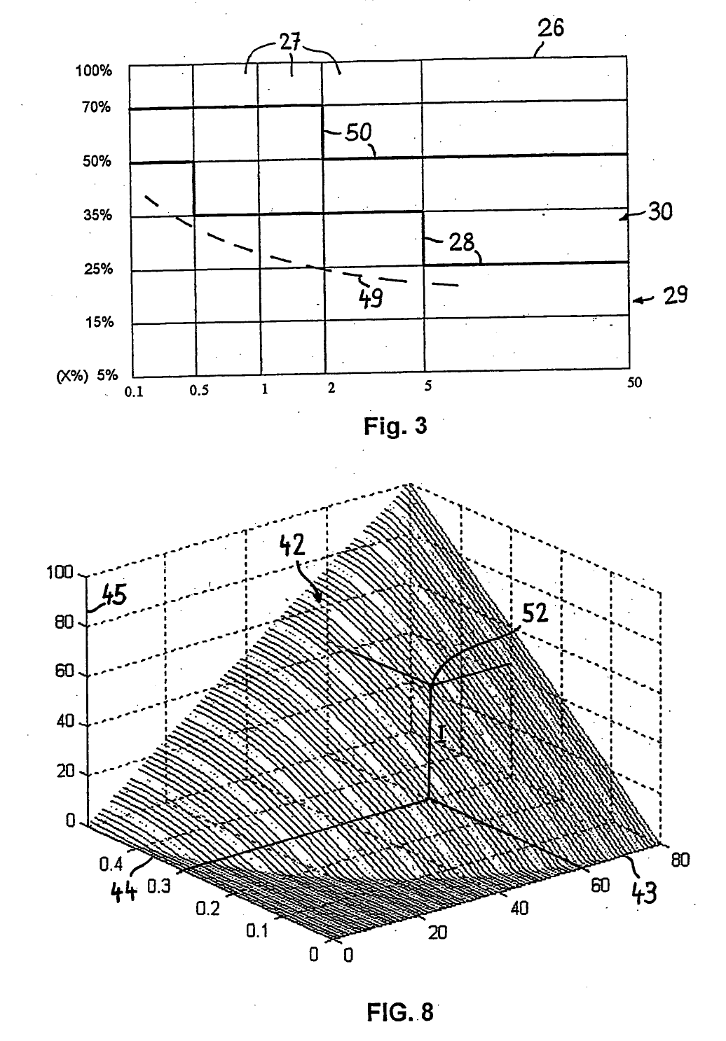

FIG. 3 is a representation of a further classifying matrix,

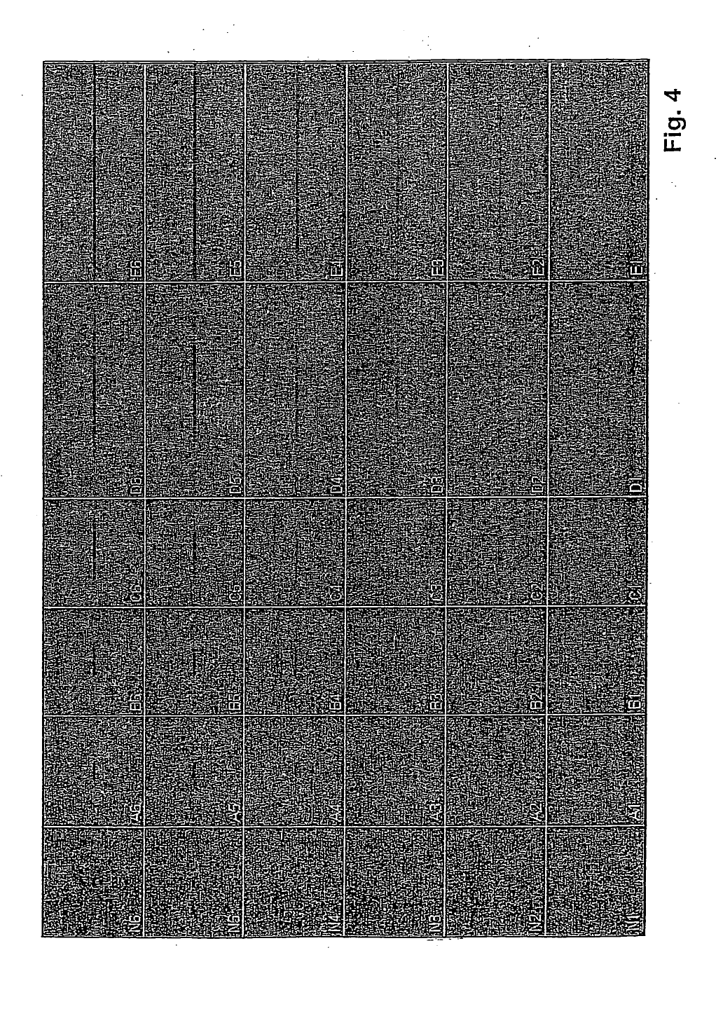

FIG. 4 is an example of a fine woven fabric,

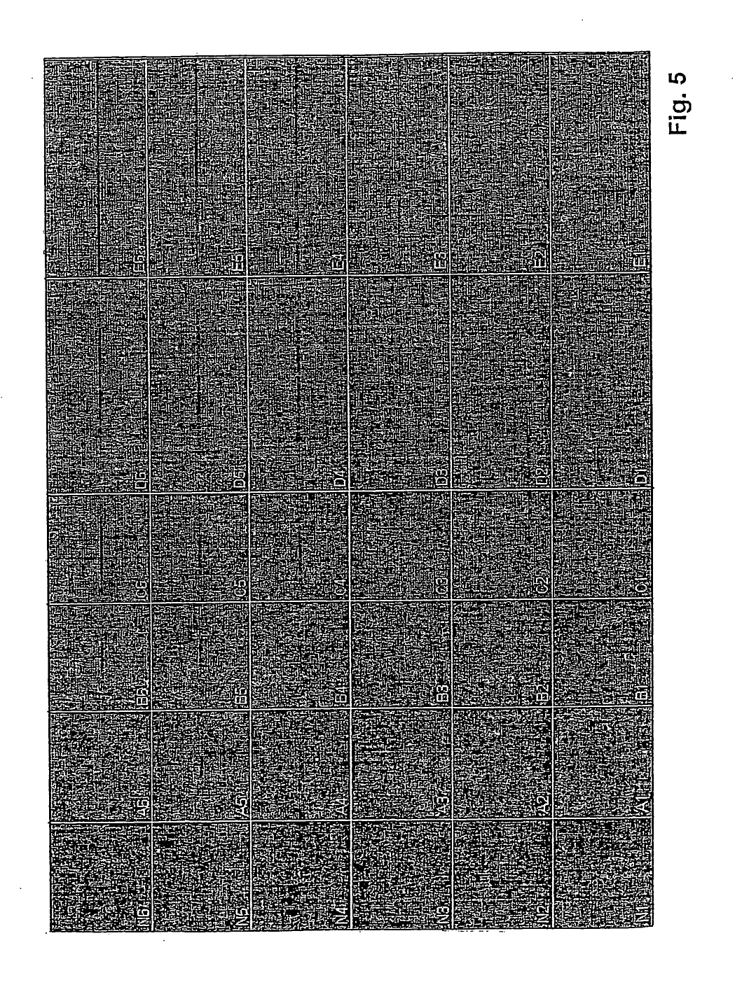

FIG. 5 is an example of a coarser woven fabric,

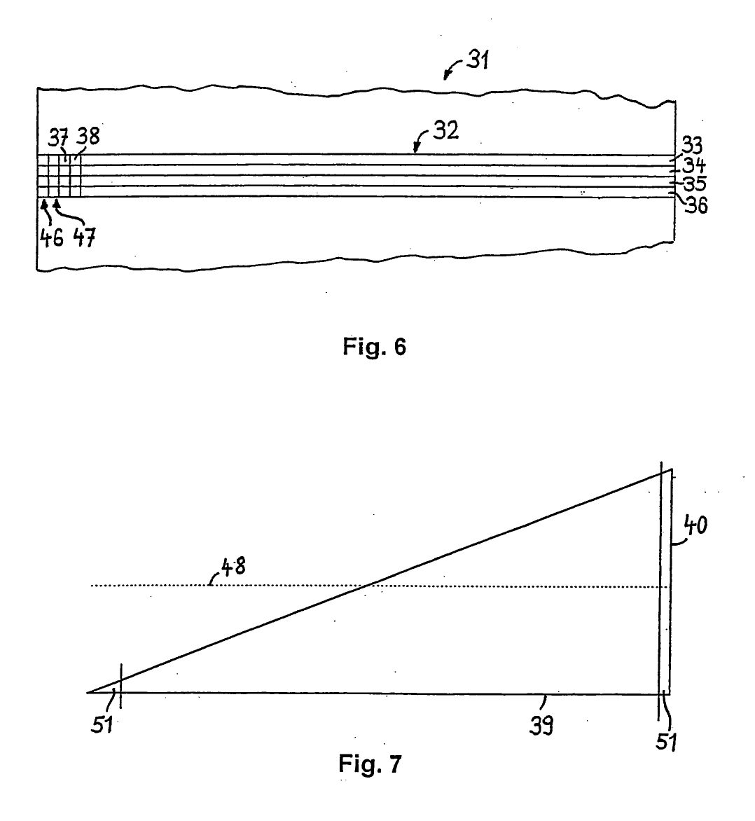

FIG. 6 is a simplified detail from a fabric,

FIG. 7 is a diagrammatic representation of grey-scale or tonal values and

FIG. 8 is a three-dimensional representation of an auxiliary function.

FIG. 1 shows a first example of a classifying matrix 1 for two parameters from a fabric for which values are to be plotted along axes 2 and 3. Parameters of this kind are, for example, the length and the intensity of a defect in the textile fabric. Values for the length lie, for example, between 10⁻¹ and 10⁴ mm. Values for the intensity of the defect lie, for example, between 0 or X% and 100%. The classifying matrix 1 is divided into fields or classes by vertical lines 4 to 8 and horizontal lines 9 to 15, which form class limits. A step line 16, drawn in comparatively thickly, divides the classifying matrix 1 further into a lower area 17 and an upper area 18. Individual defects 19 to 23 are also entered in the classifying matrix 1 and represented diagrammatically such that they indicate defects, for instance, as they belong in the relevant class. The step line 16 represents, for example, an upper limit for an area 17 in which admissible defects lie.

FIG. 2 shows an example of a textile fabric such as, e.g. a woven fabric 24 comprising defects. The defects drawn in diagrammatically here are also entered in the classes of the classifying matrix 1 and, so far as they are shown here, also given the same reference numbers 19 to 23. As this is a woven fabric, it is to be expected that the majority of the defects will become apparent in the direction of the warp threads or the direction of the weft threads. They therefore lie approximately at right angles to one another here. Here a further defect 25 concerns, for example, a plurality of warp threads lying side by side at the same time or concerns an unwanted pick in the woven fabric, which is why it is relatively wide. However in the case of a knitted fabric it is to be expected that the most frequent defects will be oriented in a different direction to one another, which is not shown here. This then depends on the stitch construction which is selected for the knitted fabric or on the structure. In so-called “non-wovens” the defects are predominantly oriented in random fashion.

FIG. 3 shows a further example of a classifying matrix 26 whose fields or classes 27 may be of unequal size or extent. A step line 28 likewise divides the classifying matrix into a lower area 29 and an upper area 30. Here the lower area 29 is obviously larger than the lower area 17 of FIG. 1, which is to be attributed to the higher step line 28. This means that this classifying matrix 26 is provided for a fabric which, for example, consists of thicker yarn and which may in addition also comprise fewer tight interlacing points between the yarns than in the case of the fabric for which the classifying matrix 1 is provided. Consequently events with higher intensity values, when compared compared with FIG. 1, are also arranged below the step line 28, as events of this kind in coarsely structured fabrics are not to be assessed as defects.

FIG. 4 shows an example for a fine fabric, while FIG. 5 shows an example for a comparatively coarse fabric. Approximately the same defects are incorporated into both figures. A comparison of the two figures shows that the defects are more conspicuous in FIG. 4 than in FIG. 5 and that certain defects which are found immediately in FIG. 4 cannot be identified at all in FIG. 5. This applies in particular to defects which lie in the left-hand half of the figure.

FIG. 6 shows a detail 31 from a fabric with a so-called camera line 32. The camera line 32 corresponds to that part of the fabric which is photographed by a camera sweeping over the fabric. The camera line 32 comprises a plurality of lines 33-36 consisting of a number of pixels arranged in a row such as, e.g. pixels 37, 38, which here are considerably enlarged and represented diagrammatically. The camera line 32 is the electronic image of a detail of the fabric, this detail already being divided into pixels with associated grey-scale or tonal values.

FIG. 7 is a diagrammatic representation of a stage in the processing which can take place on the basis of the recorded camera line 32. For each camera line 32 the grey-scale or tonal values of the recorded pixels 37, 38, etc. are to be plotted such that they are arranged according to their intensity or brightness. This produces a representation with a horizontal axis 39, along which a position is provided for each recorded pixel, and a vertical axis 40 for values of the intensity or brightness of the pixels. These pixels are recorded such that they are arranged according to their intensity or brightness or the magnitude of the values for the intensity or brightness. Thus the brightest pixels or those with the least intense colour and the darkest pixels or those with the most intense colour are to be found on the right-hand side. A mean value 48 is represented by a broken line.

FIG. 8 is a representation of a method by which a measure of the visually perceptible intensity of the defect can be determined from the measurable quantities such as defect width and contrast of the defect. Thus FIG. 8 shows a conical area 42 in a three-dimensional space which is represented by horizontal axes 43, 44 and a vertical axis 45. Values for the contrast are indicated in percentages along the axis 43, values for the width of a defect along the axis 44 in mm and values for the intensity of the defect along the axis 45, likewise in percentages. The intensity of a defect can be determined with this representation, as will be explained in the following, on the basis of the measured width of a defect and of the ascertained contrast of the defect. The intensity is a measure of how conspicuous a defect is to an observer upon observing the fabric. A defect of high intensity has a more disturbing effect for the observer than a defect of low intensity. A defect of high intensity is identified far more quickly and reduces the value of a fabric to a far greater extent. It is intensity which is in question here because it is to combine the effect of the contrast and that of the width of a defect. Thus defects of differing width and differing contrast levels are easier to compare. This also results in a massive reduction of data.

The mode of operation of the invention can be explained in two parts, i.e. firstly the creation of a suitable classifying matrix and secondly the classification of the defects recorded in the fabric by means of this classifying matrix.

The creation of a classifying matrix or a classifying diagram according to FIGS. 1 and 3 will firstly be described. A horizontal axis 2 is firstly set, along which axis values for the lengths of possible defects are recorded, as may possibly be expected for a fabric under consideration or textile fabrics in general. Values of this kind may lie between one tenth of a millimetre and several metres. A vertical axis 3 for values of an intensity from 0 or X%-100% is then set. A decision must subsequently be made as to how many classes are desired. The number of lines 4 to 15 is then obtained from this. However it is advisable to use just one and always the same classifying matrix for all fabrics which are to be evaluated. It thus becomes far easier to compare the effects of the defects in different fabrics with one another. In a further step the lower and the upper area 17, 18 or 29, 30 are to be defined, this taking place through the form and the position of the step line 16, 28 and the association of a basic value corresponding to 0 or X% for the lower boundary or the position of the axis 2. Since each field or each class of the classifying matrix 1 stands for one group of possible defects, it is now a matter of deciding which defects or events have a disturbing effect on account of their length and their intensity in a given fabric and which defects are tolerable and are therefore also simply to be rated as events without an effect. It is known that a given defect, for example in the fabric according to FIG. 5, is not at all identifiable, but that it would have to have a disturbing effect in the fabric according to FIG. 4. There are also events which consist of particularly distinct irregularities in the fabric yet which cannot be considered as defects. These circumstances must be taken into account by the step line 16, 28 or the upper limit of the areas 17, 29.

Various methods of procedure can be selected in order to distinguish between tolerable defects and intolerable defects. The simplest procedure would be to create a relatively high number of reference defects and to view each of these defects against the background of the given actual fabric to be evaluated, to compare them and possible classify them and in this respect decide on a subjective basis which defects have no disturbing effect or which defects definitely have a disturbing effect. If there are as many reference defects as fields or classes in the classifying matrix 1, it is possible, through the above-mentioned subjective comparison, to directly determine those classes whose defects either have or do not have a disturbing effect. This then produces a limit line between classes of disturbing defects and classes of non-disturbing defects, this being the step line 16, 28. As relatively small, low-contrast defects are also conspicuous in fine fabrics, the step line 16 according to FIG. 1 is lower than the step line 28 according to FIG. 3, which is provided for more structured fabrics such as, for instance, according to FIG. 5.

A further, more complex and precise way of also automatically determining the upper limit or step line 16, 28 may take place as follows. Firstly a minimal intensity is to be established, this being associated with the lowest intensity class (e.g. 0 or X%). This limit is to be located so low that it is also possible to record slight defects in highly homogeneous fabrics. Since the intensity in the case of small, punctiform defects corresponds approximately to the grey-scale value of the pixels, the intensity scale can be brought into line with the grey-scale value range of the pixels under consideration. The intensity scale may lie, for example, between ±64, 128, 256, etc., depending on the number of bits used in the calculation. The intensity 100% is assigned to the maximum grey-scale value, which corresponds, for example, to 64, 128 or 256. A value of 5% thereof may be appropriate as minimal intensity. It is thus possible, for example, to prevent, in the case of highly homogeneous woven fabrics, the lower limiting value from being reduced to such an extent that normal irregularities in the imaging result in pseudodefects.

Once scaling for the values of the intensity and the length of the defects has been determined, the step lines 16, 28 are to be established such that only a few events in the flawless woven fabric image are identified as so conspicuous that these exceed the step line and are counted. The step line 16, 28 must be determined for a fabric under consideration. The procedure in this respect may be as follows:

1) For example, a camera records the fabric and forms an image of it through pixels in the camera line 32. Intensity or brightness values are associated with the pixels recorded by the camera according to the predetermined scale. These values are to be plotted from a representative quantity of pixels from a flawless portion of the fabric such that they are arranged according to their magnitude or stored in a memory, as illustrated by FIG. 7. This may also take place, for example, such that, for each column 46, 47, etc., a mean value of the grey-scale values of the pixels in the column is established in the camera line, only the mean values being arranged and stored. The result is just one pixel pattern with pixels whose values are arranged as indicated above for each camera line 32.

2) This is followed by the creation of a group 51 (FIG. 7) with pixels, this group comprising those pixels which are of the highest or lowest intensity or brightness or exhibit the greatest positive or negative deviation from the mean value 48 (FIG. 7). This group may comprise, for example, 10, 15, 20 or a different number of pixels, the pixels of the lowest intensity applying to dark fabrics and the pixels of the highest intensity applying to bright fabrics. A value in a group 51 may be taken as the upper limit for areas 17, 29.

3) However the median value of the brightness, of the intensity or of the deviation may also be determined from the group 51 for the upper limit. This median value may then indicate a value for the intensity for the step line 16, 28 in its central area relating to the length of the defects. It applies to defects which are rather longer. If the deviation is taken as a basis, this must be related to the mean value 48 in order to obtain a value for the step line 16, 28. However this median value must also be converted to a % value which matches the scaling on the axis 3.

4) A further step is desirable for the step line in the area of short defects. According to previous experience, short defects are assessed differently to longer defects in known methods for identifying defects in textile fabrics, as are known, for example, from WO98/08080 and must also be applied in this connection. This procedure is provided by the device or the method by means of which the pixels are recorded and which may comprise special properties which result in this kind of differentiated treatment of defects.

It is therefore appropriate to provide a correction which increases the value for the step line 16, 28 for short defects. The above-mentioned properties can be represented by a characteristic as represented in FIG. 3 by the curve 49. A characteristic of this kind, as represented by the curve 49, is either already known or must be established through tests with the given device. If it is assumed that values for the step line 28 which apply to the axis 2 for the right-hand half, for instance, are established by the above-mentioned method, the curve 49 indicates the extent to which it would be necessary to increase the step line in the left-hand half of FIG. 3. Here fields or classes in which the curve 49 falls should fall as a whole below the step line 28. This also takes account of the easily comprehensible circumstance according to which short defects in the fabric are rather covered by the structure of the fabric, so that short defects of this kind must be conspicuous through greater contrast with the fabric in order to be identifiable.

In order to find a measure of and also scaling for the intensity of a pixel or defect, it may be assumed, for example, that the intensity is in this case influenced by the width and by the contrast of a defect. In this respect FIG. 8 shows one possible way of determining the intensity from the width and the contrast by means of a model. The model is represented by the surface of a cone, i.e. the conical area 42, and therefore predetermined . . . on which values for the intensity lie. A value for the intensity can now be found from the value for the width of a defect, which is given by the number of pixels, and from the contrast, which is established from the brightness values of the pixels, by plotting the values for width and contrast along the relevant axes 44, 43 and then setting up a perpendicular at the point of intersection in the plane of the two axes 43, 44. The piercing point 52 of this perpendicular with the conical area 42 produces the sought intensity, which is given by the height of the conical area 42 above the plane.

Once the classifying matrix 1, 26 with the step line 16, 28 has been established, it is then a question of identifying the defects in a predetermined fabric and classifying them according to the classifying matrix. A method as described in WO98/08080, for example, is used for this purpose. In this case each camera line is represented by its pixels and it is now possible to store these pixels according to their intensity or brightness in the classifying matrix 1, 26. As new camera lines are always being scanned, there may be a plurality of allocations in succession for certain fields or classes, so that these can also be counted, and a count can be entered in the relevant class.

The step lines 16, 28 therefore represent limits which depend on the woven or knitted fabric which is under consideration. Pixels in the fabric which do not reach these limits are not processed by the system. Pixels which lie above these limits need not necessarily denote defects. However they indicate particularly distinct irregularities. Viewed from the textile aspect, these may also be of interest, and it may therefore be appropriate to count these as events. For such reasons the classifying matrix may therefore even comprise three zones. The bottom zones, such as the areas 17 and 29, reach from the bottom intensity limit or axis 2 up to the step lines 16, 28. Above lies a zone of simple event counting and even higher the defect zone. The areas 18, 30 are divided as desired by the user, while the step lines 16, 28 may be automatically determined. FIG. 3 shows a division of this kind into three zones with a further step line 50.

1. Method for evaluating defects in textile fabrics, wherein two parameters are selected for the evaluation, a classifying matrix is created in which values of the parameters determine class limits, and class limits divide the classifying matrix into fields, the classifying matrix is further divided into at least two areas and a mean value is established for pixels from the flawless fabric for one parameter, and a limit between two areas is established in accordance with a group of pixels with the greatest deviation of the parameter from the mean value, further wherein the division takes place into at least two areas along the class limits, values in the fabric are recorded from pixels, which represent this, and the values are arranged according to the two selected parameters in the classifying matrix, and wherein pixels which are arranged in one area of the classifying matrix indicate a possible defect in the fabric.

2. Method according to claim 1, wherein the intensity of the pixels and the extent thereof are recorded as parameters, and wherein the extent is effected by a plurality of adjacent pixels.

3. Method according to claim 2, wherein the length is measured as extent, this being formed by a plurality of adjacent pixels of an intensity which is similar, yet deviates from a reference value.

4. Method according to claim 1, wherein the area for possible defects is further divided into a first area for admissible defects and a second area for inadmissible defects.

5. Method according to claim 1, wherein the limit between the two areas is automatically determined.

6. Method according to claim 5, wherein the automatic determination of the upper limit is carried out by means of brightness or intensity values which are recorded and arranged according to magnitude, wherein a value which lies in a group formed by a predeterminable number of the most extreme values is established as the upper limit.

7. Method according to claim 6, wherein the median value of the brightness or intensity values is determined as the upper limiting value within the group.

8. Method according to claim 5, wherein the upper limit for a value range of one parameter is varied.
